(19) United States
(12) Patent Application Publication
(10) Pub. No.: US 2017/0108093 A1
(43) Pub. Date: Apr. 20, 2017

(54) TENSIONER

(71) Applicant: TSUBAKIMOTO CHAIN CO., Osaka (JP)

(72) Inventors: Masanori Watanabe, Osaka-shi (JP); Kohei Kunimatsu, Osaka-shi (JP); Osamu Yoshida, Osaka-shi (JP)

(73) Assignee: TSUBAKIMOTO CHAIN CO., Osaka (JP)

(21) Appl. No.: 15/288,049

(22) Filed: Oct. 7, 2016

(30) Foreign Application Priority Data
Oct. 16, 2015 (JP) 2015-204541

(51) Int. Cl. F16H 7/08

(52) U.S. Cl. CPC F16H 7/0848; F16H 2007/0812; F16H 2007/0859

(57) ABSTRACT

To provide a simple-structured tensioner capable of minimizing an increase in production cost, and avoiding performance degradation of its check valve resulting from a buildup of oil pressure inside an oil pressure chamber, while securing good assemblability of the check valve. A check valve 50 is provided in the tensioner 10 in which a ball seat 52 is fixedly set to a housing 30 or a plunger 20 and has a retainer receiving recess 52b for setting a retainer 53 on one side facing an oil pressure chamber 11.

### BACKGROUND OF THE INVENTION

1. Field of the Invention

The present invention relates to a tensioner that applies appropriate tension to a running chain, belt, or the like.

2. Description of the Related Art

In the prior art, using a tensioner to maintain tension in a chain, etc. appropriate has been common practice. For example, a known chain guide mechanism uses a tensioner to urge a tensioner lever for slidably guiding an endless transmission chain passed over respective sprockets of a crankshaft and cam shafts inside an engine room, so as to maintain tension in the chain, etc. appropriate.

One known tensioner used in such a chain guide mechanism includes, as shown in FIGS. 5 and 6, a housing 530 having a plunger bore 531 that is opened to a front side, a plunger 520 slidably inserted in the plunger bore 531, and biasing unit 540 that urges the plunger 520 toward the front side (see, for example, Japanese Patent Application Laid-open Nos. 2009-192031, 2006-144958, and 2008-95850).

In such a tensioner, oil is supplied to an oil pressure chamber 511 formed between the plunger bore 531 and the plunger 520, so that the plunger 520 is biased toward the front side by the oil in the oil pressure chamber 511. As the plunger 520 reciprocates, oil flows through the small gap between the plunger 520 and the plunger bore 531, and the flow resistance exerts a damping effect of slowing down the reciprocal movement of the plunger 520.

In such a tensioner, a check valve 550 is provided for preventing the oil from flowing out from the oil pressure chamber 511 while allowing the oil to flow into the oil pressure chamber 511. The check valve 550 includes a check ball 551, a ball seat 552 having a ball seat part for the check ball 551 to sit on, and a retainer 553 that restricts the movement of the check ball 551.

### SUMMARY OF THE INVENTION

Such a tensioner, however, may sometimes be subjected to an excessive load resulting from an engine failure or the like, in which case the oil pressure inside the oil pressure chamber 511 may rise significantly. In a tensioner such as the one described in Japanese Patent Application Laid-open No. 2009-192031 and shown in FIG. 5, the ball seat 552 is press-fitted in a seat receiving recess 555a that is formed in a side face on a rear side of the ball guide 555 that is fixedly set in the housing 530 (i.e., opposite side of the ball guide 555 from the side facing the oil pressure chamber 511). In such a case, when a buildup of oil pressure inside the oil pressure chamber 511 occurs, the ball seat 552 may be displaced in a manner such as the ball seat 552 coming out of the seat receiving recess 555a due to the increased oil pressure inside the oil pressure chamber 511, for example, which may lead to performance degradation of the check valve 550.

A possible measure for preventing such displacement of the ball seat 552 may be to form the inner diameter of the seat receiving recess 555a and the outer diameter of the ball seat 552 with a higher degree of precision so as to increase the strength with which the ball seat 552 fits in the seat receiving recess 555a, i.e., to increase the force of the seat receiving recess 555a retaining the ball seat 552. This, however, would require formation of the seat receiving recess 555a and ball seat 552 with a high degree of precision and therefore leads to the problem of increased production cost.

Another possible measure would be to fixedly set the ball seat 552A in the housing 530 by press-fitting, as in the check valve 550A incorporated in the tensioners of Japanese Patent Application Laid-open Nos. 2006-144958 and 2008-95850 shown in FIG. 6, with a retainer 553A having a flange that makes contact with the housing 530 and being fitted with one end of the ball seat 552A facing the oil pressure chamber 511. This way, displacement of the ball seat 552A or retainer 553A that may result from a buildup of oil pressure inside the oil pressure chamber 511 can be prevented. However, in this case, when assembling the tensioner, the ball seat 552A would have to be press-fitted to the housing 530 before the check ball 551A is set on the ball seat 552A, and the retainer 553A is fitted to the ball seat 552A after that, which all have to be done in a constricted space inside the housing 530. Thus the assemblability of the tensioner would be greatly compromised. In the case with the check valve 550A having the structure described above, there is a limitation on the position where the check valve 550A can be installed inside the tensioner. For example, the check valve 550A could not be set at a middle position inside the plunger hole 521.

When the ball seat 552B and retainer 553B are in contact with the plunger 520 or the like on the opposite side from the oil pressure chamber 511 as in the check valve 550B of another type incorporated in the tensioners of Japanese Patent Application Laid-open Nos. 2006-144958 and 2008-95850 shown in FIG. 6, the displacement of the ball seat 552B or retainer 553B resulting from the buildup of oil pressure inside the oil pressure chamber 511 may be prevented. However, this only applies to cases where the check valve 550B is set to a specific position inside the tensioner.

Also, with a further increase in engine output in future, the load input conditions of the tensioner are expected to become harsher. Therefore, a reliable check valve 550 that can withstand an excessive input is more and more sought after.

The present invention solves these problems and it is an object of the invention to provide a simple-structured tensioner capable of minimizing an increase in production cost, and avoiding performance degradation of its check valve resulting from a buildup of oil pressure inside an oil pressure chamber, while securing good assemblability of the check valve.

The present invention solves the problems described above by providing a tensioner that includes: a plunger having a plunger hole that is opened to a rear side; a housing having a plunger bore that is opened to a front side for accommodating the plunger; biasing unit accommodated inside an oil pressure chamber formed between the plunger bore and a rear end of the plunger such as to be able to expand and contract and to urge the plunger toward the front side; and a check valve that allows oil to flow into the oil pressure chamber and prevents the oil from flowing out from the oil pressure chamber. The check valve includes a check ball, a ball seat having a ball seat part for the check ball to sit on, and a retainer that restricts movement of the check ball. The ball seat is fixed to either the housing or the plunger, and the ball seat has a retainer receiving recess for setting the retainer on one side facing the oil pressure chamber.

According to one aspect of the present invention, the ball seat is fixedly set to the housing or the plunger, and has a retainer receiving recess for setting a retainer on one side facing an oil pressure chamber. When the tensioner is subjected to an excessive load and the oil pressure inside the oil pressure chamber rises, the ball seat and the retainer are reliably prevented from being displaced, and thus performance degradation of the check valve is prevented with a simple structure.

Since the retainer receiving recess is formed in the ball seat, the check ball and the retainer can be assembled to the ball seat and thus the check valve can be in one piece, which allows handling of the check valve as a single unit during assembly of the tensioner and enables the assembling work to be achieved easily.

Displacement of the retainer and others that may occur by a buildup of oil pressure inside the oil pressure chamber can be prevented irrespective of the strength with which the retainer fits in the retainer receiving recess, and therefore the machining precision requirements for the retainer and retainer receiving recess can be kept low.

According to another aspect of the present invention, an inner spring that is in contact with the retainer and urges the retainer toward the ball seat is set radially inside the coil spring that is set inside the oil pressure chamber and urges the plunger toward the front side. The inner spring is set this way by making efficient use of the space radially inside of the coil spring, whereby the retainer can be installed stably relative to the ball seat. Also, since the retainer need not be fixedly attached to the ball seat by press-fitting or the like, the degree of design freedom of the check valve is increased.

### BRIEF DESCRIPTION OF THE DRAWINGS

FIG. 1 is a cross-sectional view illustrating a tensioner according to a first embodiment of the present invention;

FIG. 2 is a perspective view illustrating a check valve assembled into the tensioner shown in FIG. 1;

FIG. 3 is an exploded perspective view of the check valve;

FIG. 4 is a cross-sectional view illustrating a tensioner according to a second embodiment of the present invention;

FIG. 5 is a cross-sectional view illustrating a conventional tensioner; and

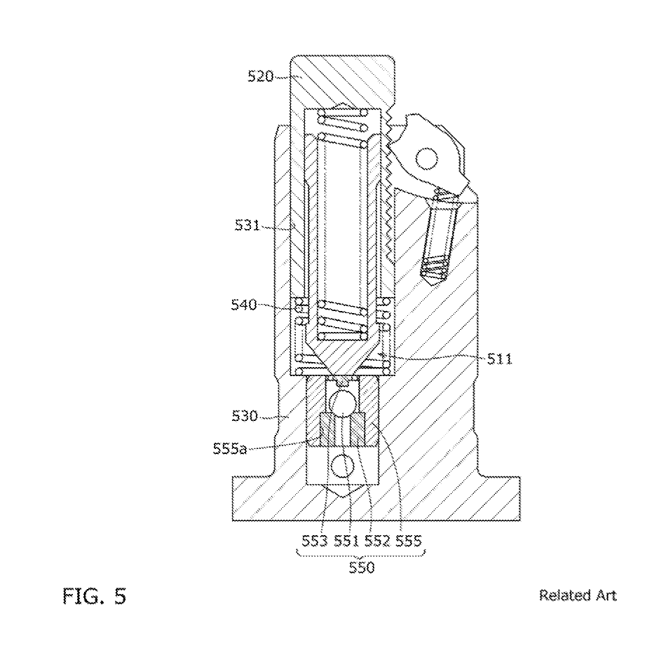

FIG. 6 is a cross-sectional view illustrating another conventional tensioner.

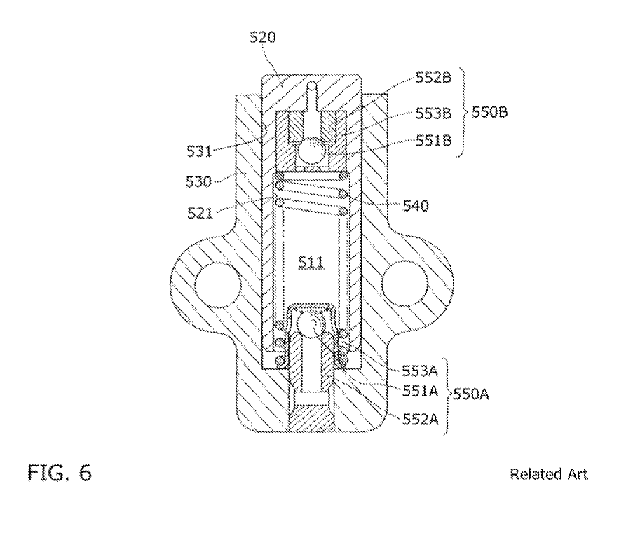

### DESCRIPTION OF THE PREFERRED EMBODIMENTS

A tensioner 10 according to a first embodiment of the present invention will be described with reference to the drawings.

First, the tensioner 10 of this embodiment is incorporated in a chain transmission used in a timing system or the like of a car engine. The tensioner is attached to an engine block to apply appropriate tension to the slack side of a transmission chain passed over a plurality of sprockets via a tensioner lever to reduce vibration during the drive.

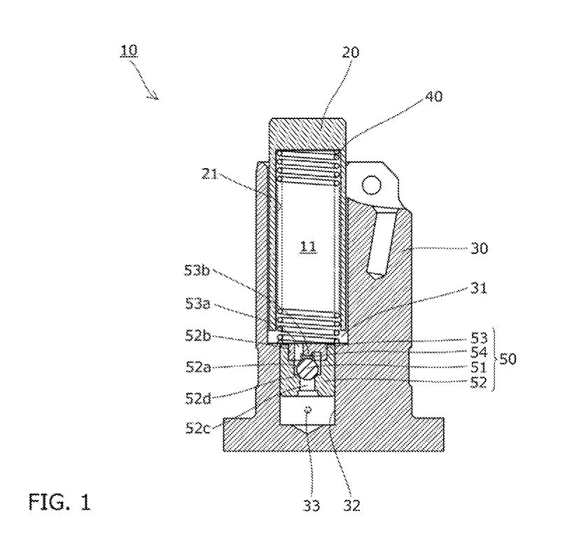

The tensioner 10 includes, as shown in FIG. 1, a plunger 20 having a plunger hole 21 that is opened to a rear side, a housing 30 having a plunger bore 31 for accommodating the plunger 20, a coil spring 40 that is biasing unit accommodated inside an oil pressure chamber 11 formed between the plunger bore 31 and the rear end of the plunger 20 such as to be able to expand and contract and to urge the plunger 20 toward a front side, and a check valve 50 that allows the oil to flow into the oil pressure chamber 11 and prevents the oil from flowing out from the oil pressure chamber 11.

Hereinafter, various constituent elements of the tensioner 10 will be described with reference to the drawings.

The plunger 20 is made of metal such as iron or the like and inserted in the plunger bore 31 such as to move back and forth in the front to back direction, as shown in FIG. 1.

The housing 30 is made of aluminum alloy, synthetic resin or the like, and includes, as shown in FIG. 1, the cylindrical plunger bore 31 that is opened to the front side, a cylindrical valve accommodating hole 32 formed continuously on the rear side of the plunger bore 31 and having a smaller diameter than that of the plunger bore 31, and an oil supply hole 33 that extends through an outer wall of the housing 30 all the way into the valve accommodating hole 32. This oil supply hole 33 functions as a part that supplies oil from the outside of the housing 30 into the oil pressure chamber 11.

The coil spring 40 has one end abutting on the bottom of the plunger hole 21 (front side portion of the plunger 20) and the other end arranged in contact with the bottom of the plunger bore 31.

As shown in FIG. 1, the check valve 50 allows the oil to flow in from the outside of the housing 30 through the oil supply hole 33 into the oil pressure chamber 11, and prevents the oil from flowing out from the oil pressure chamber 11 through the oil supply hole 33. As shown in FIG. 1, the check valve is disposed inside the valve accommodating hole 32.

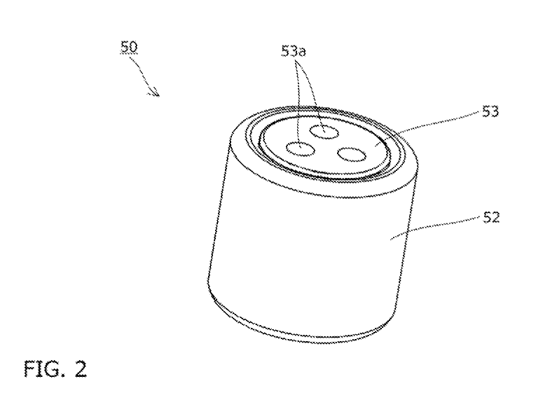

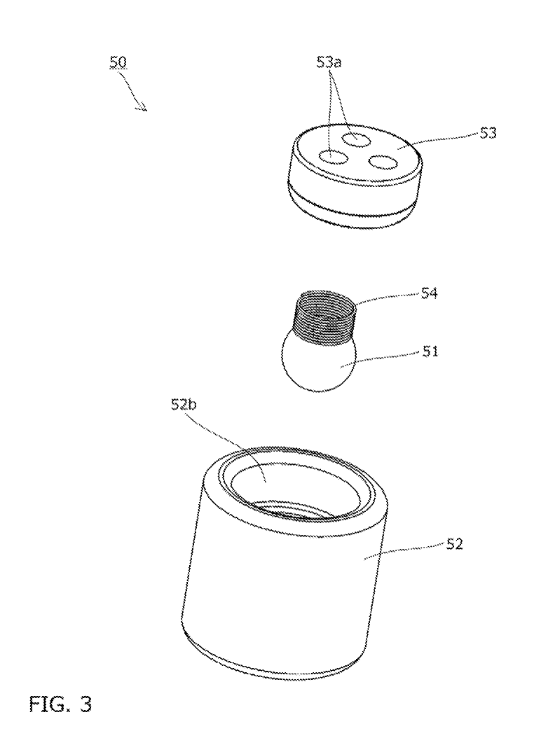

As shown in FIGS. 1 to 3, the check valve 50 is made up of a spherical check ball 51, a ball seat 52 having a check ball holding part 52a that is opened to the side facing the oil pressure chamber 11 (front side in this embodiment), a retainer 53 that restricts the movement of the check ball 51, and a ball spring 54 disposed between the check ball 51 and the retainer 53. These components of the check valve 50 are made of metal or the like.

The ball seat 52 is press-fitted into the valve accommodating hole 32 of the housing 30 and thus fixed to the housing 30, as shown in FIG. 1. The ball seat 52 may be fixed to the housing 30 by other means than press-fitting. The ball seat 52 includes, as shown in FIGS. 1 to 3, the check ball holding part 52a, a retainer receiving recess 52b formed continuously on the front side of the check ball holding part 52a, and an oil hole 52c that extends from the check ball holding part 52a to the rear side of the ball seat 52.

The retainer receiving recess 52b has a larger diameter than that of the check ball holding part 52a as shown in FIG. 1, while the oil hole 52c has a smaller diameter than that of the check ball holding part 52a. The step between the check ball holding part 52a and the oil hole 52c (bottom of the check ball holding part 52a) functions as a ball seat part 52d for the check ball 51 to sit on in annular tight contact therewith.

The retainer 53 is press-fitted in the retainer receiving recess 52b, as shown in FIG. 1. As shown in FIGS. 1 to 3, the retainer 53 has a plurality of oil holes 53a that extend through in the front to back direction, and a spring support part 53b that protrudes from the rear face of a top plate of the retainer 53 toward the rear side.

The ball spring 54 is arranged to fit around the spring support part 53b as shown in FIG. 1 and urges the check ball 51 toward the ball seat part 52d. This ball spring 54 is not an essential constituent element and may not be needed depending on the embodiment.

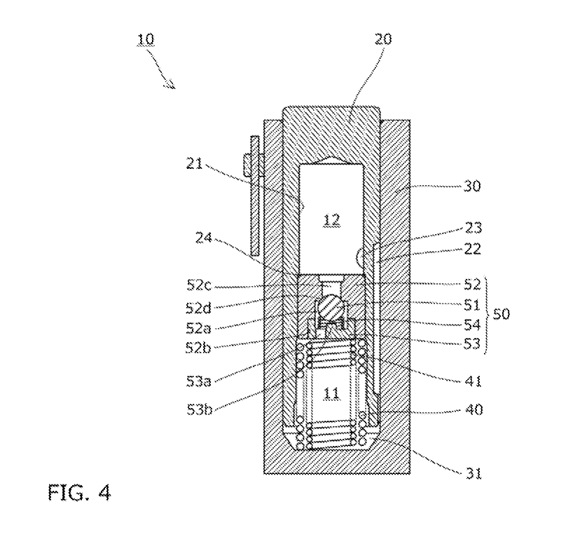

Next, a tensioner 10 according to a second embodiment of the present invention will be described with reference to FIG. 4. The second embodiment is, in part, exactly the same as the previously described first embodiment. Therefore, the configuration will not be described again except for different features.

In the tensioner 10 of the second embodiment, as shown in FIG. 4, the check valve 50 is set inside the plunger hole 21. Therefore, the internal space formed between the housing 30 and the plunger 20 is divided into the oil pressure chamber 11 on the rear side and an oil reservoir chamber 12 on the front side.

The plunger 20 includes a connection/adjustment groove 22 formed in an outer circumferential surface thereof, and a through hole 23 for supplying oil from the connection/adjustment groove 22 into the oil reservoir chamber 12. The housing 30 includes an oil supply hole (not shown) that extends through the outer wall of the housing 30 all the way into the valve accommodating hole 32. These connection/adjustment groove 22, through hole 23, and oil supply hole (not shown) function as an oil supply part that supplies oil from the outside of the housing 30 into the oil reservoir chamber 12. The connection/adjustment groove 22 may be formed at least in one of the outer circumferential surface of the plunger 20 and an inner circumferential surface of the plunger bore 31. The oil supply part for supplying oil from the outside of the housing 30 into the oil reservoir chamber 12 is not limited to the specific form described above.

Moreover, in the tensioner 10 of the second embodiment, as shown in FIG. 4, the inner spring 41 pressing the retainer 53 toward the ball seat 52 and being in contact with the retainer 53 is set radially inside the coil spring 40. The inner spring 41 has one end in contact with the retainer 53 and the other end in contact with the bottom of the plunger bore 31.

In the tensioner 10 of the second embodiment, as shown in FIG. 4, a step 24 is formed in an inner wall portion of the plunger hole 21, and this step 24 restricts the movement of the ball seat 52 toward the front side. With this step 24, the check valve 50 is prevented from moving toward the front side due to the urging forces of the coil spring 40 and inner spring 41.

While the ball seat 52 is fixed to the plunger 20 in the manner described above in the embodiment, the ball seat 52 can be fixed to the plunger 20 by any other means, such as press-fitting the ball seat 52 into the plunger hole 21.

While the embodiments of the present invention have been described in detail, the present invention is not limited to the above-described embodiments and may be carried out with various design changes without departing from the scope of the present invention set forth in the claims.

For example, various configurations of the embodiments described above may be freely combined to form other tensioners.

While the tensioner was described as a component to be incorporated in a timing system of a car engine in the embodiments above, the purpose of use of the tensioner is not limited to this specific application.

Also, while the tensioner was described as a component that applies tension to a transmission chain with a tensioner lever in the embodiments above, the plunger can directly guide the transmission chain slidably with a distal end thereof to apply tension to the transmission chain.

The tensioner may not necessarily be applied to a transmission mechanism with a transmission chain but can also be used for similar transmission mechanisms that use belts, ropes and the like, and can be applied in a variety of industrial fields where it is required to apply tension to an elongated component.

While the housing accommodating the plunger is described as the component known as a housing that is attached to an engine block or the like in the embodiments described above, the housing is not limited to the specific form described above and may be a cylindrical component known as a sleeve inserted into a body hole formed in the housing.

While the retainer is press-fitted into the retainer receiving recess formed on one side of the ball seat facing the oil pressure chamber in the embodiments described above, installation of the retainer is not limited to the manner described above, and the retainer may simply be set inside the retainer receiving recess, when there is provided an inner spring, etc.

What is claimed is:

1. A tensioner comprising: a plunger having a plunger hole that is opened to a rear side; a housing having a plunger bore that is opened to a front side for accommodating the plunger; biasing unit accommodated inside an oil pressure chamber formed between the plunger bore and a rear end of the plunger such as to be able to expand and contract and to urge the plunger toward the front side; and a check valve that allows oil to flow into the oil pressure chamber and prevents the oil from flowing out from the oil pressure chamber,
the check valve including a check ball, a ball seat having a ball seat part for the check ball to sit on, and a retainer that restricts movement of the check ball,
the ball seat being fixed to either the housing or the plunger, and
the ball seat having a retainer receiving recess for setting the retainer on one side facing the oil pressure chamber.

2. The tensioner according to claim 1, wherein the biasing unit is a coil spring set inside the oil pressure chamber, and
the tensioner further comprises an inner spring set radially inside the coil spring in contact with the retainer and urging the retainer toward the ball seat.

3. The tensioner according to claim 1, wherein the housing includes an oil supply hole for supplying oil from outside of the housing into the oil pressure chamber, and
the check valve is set between the oil supply hole and the oil pressure chamber.

4. The tensioner according to claim 1, wherein the check valve is set inside the plunger hole and divides an internal space formed between the housing and the plunger into the oil pressure chamber and an oil reservoir chamber, and
the housing and the plunger include an oil supply part formed therein for supplying oil from outside of the housing into the oil reservoir chamber.
